(19) United States
(12) Patent Application Publication
(10) Pub. No.: US 2003/0121715 A1
(43) Pub. Date: Jul. 3, 2003

(54) Electric power assist steering system with roller gearbox

(76) Inventors: Sunil Palakodati, Canton, MI (US); Bruce Allen Bowling, Redford, MI (US); Edward Francis McElmeel, Milan, MI (US); James Richard Robertson, Walled Lake, MI (US)

Correspondence Address: BRINKS HOFER GILSON & LIONE, P.O. BOX 10395, CHICAGO, IL, 60611, US

(21) Appl. No.: 10/041,094

(22) Filed: Dec. 28, 2001

(51) Int. Cl. B62D 5/04

(52) U.S. Cl. 180/444

(57) ABSTRACT

An electric power assist steering system includes an electric motor coupled to a steering mechanism via a roller gear mechanism. The roller gear mechanism transfers power from an electric motor output shaft to a roller pinion gear for a rack and pinion steering mechanism. In an embodiment, a roller pinion gear for use in a power assist steering system comprises a roller wheel having a plurality of radially projecting teeth about its periphery, wherein the teeth comprise pins rotatably mounted in and projecting from the periphery of the roller wheel. The present invention increases the efficiency of power assist steering systems and of vehicles utilizing same.

### FIELD OF THE INVENTION

This invention relates to the generally to the field of vehicle steering systems, and more particularly relates to an electric power assist steering system that utilizes a roller gearbox for power transfer.

### DESCRIPTION OF THE RELATED ART

A Typical Steering System

A typical steering system for a motor vehicle is illustrated in FIG. 1. The steering system 1 has rotating steering wheel 2 in the passenger compartment of the vehicle mounted to steering column 3 that is operably connected to wheels 4 via steering assembly 5. In order to reduce the amount of driver effort (i.e., torque) that is required to rotate the steering wheel, many steering systems include a power-assisted actuator. The actuator assists the operator with rotation of the steering wheel to overcome opposing forces such as road load forces on the road wheels and friction forces in the steering assembly. The amount of power assistance generally varies depending on the speed of the vehicle and the amount of effort applied by the vehicle operator to the steering wheel. Conventional power assist steering systems typically employ either hydraulic power assist or electric power assist mechanisms. Electric power assist mechanisms are being used in an increasing number of vehicles due to their reduced size and higher energy efficiency than hydraulic mechanisms.

Electric Power Assist Systems

An electric power assist steering (EPAS) system employs an electric motor for applying a controlled amount of torque to the steering assembly to assist the operator with rotation of the steering wheel. For example, the system illustrated in FIG. 1 includes electric motor 6 for power assist, and controller 7. The steering assembly may be a rack and pinion type that converts angular rotation of the steering wheel into a sliding motion of a rack to steer the wheels. The rack interacts with teeth on an assist pinion that is driven by the output shaft of motor 6 in response to signals from controller 7. The signals from controller 7 are designed to provide a relatively constant torque at the driver pinion.

An example of an EPAS rack and pinion assembly 10 is illustrated in FIG. 2. Inner tie rods 12 are connected to a rack and pinion mechanism contained within housing 14. Gearbox 16 contains a gear reduction mechanism for the assist pinion. Electric motor 18 is rigidly mounted to gear box 16 to power the assist pinion via the gear reduction mechanism. The motor output shaft directly connects to an input shaft in the gear reduction mechanism, which in the prior art was generally a worm gear shaft. A driver pinion torque sensor, as well as various other sensors, may also be included, but the driver pinion and sensors are not shown to simplify the present description. The measured torque at the driver pinion serves as an approximation of the input torque applied to the steering wheel by the vehicle operator and is commonly used to determine the amount of torque assist to be provided by the electric motor to the assist pinion. Further information about electric power assist steering systems can be found in various patents and literature references, including but not limited to U.S. Pat. No. 5,743,352, to Miller et al., and U.S. Pat. No. 6,250,419, to Chabaan et al., both of which are incorporated by reference as if reproduced in full herein.

Concerns over fuel efficiency have led to the production of smaller vehicles, vehicles with more aerodynamic shapes to reduce wind resistance, and more energy efficient components.

An electric power assist steering system offers variable assist capabilities, more efficient energy consumption, reduced mechanism complexity, increased reliability, and responsive on-demand steering assist, as well as other advantages. However, many current power assist steering systems utilize gear reduction mechanisms that utilize a conventional worm gear and have low torque transfer efficiency.

With reference to FIG. 3, a typical prior art worm gear reduction mechanism for an electric power assist steering system is illustrated. The gear reduction mechanism has a housing 40 in which is rotatably mounted a wormscrew 42 having threads 44. An assist pinion 46 is also rotatably mounted in the housing at a generally perpendicular angle to worm gear 42. The assist pinion is coupled to a pinion gear 47 having radially projecting teeth 48. Upon rotation of worm gear 42, threads 44 on wormscrew 42 engage teeth 48 on pinion gear 47 causing the assist pinion 46 to rotate. As is know in the art, the gear reduction ratio can depend on the diameter of the pinion gear and number of teeth thereon, the pitch and density of the wormscrew threads, and other factors. Thus, a gear ratio of 10:1 indicates that the wormscrew will make ten rotations for every one rotation of the pinion gear. The ratio of input torque to output torque is inversely related to the gear ratio. Hence, the ratio of output torque to input torque will increase as the gear ratio increases. Unfortunately, power is lost due to sliding friction caused by the sliding engagement of the wormscrew threads with the teeth on the pinion gear. For example, inefficiencies ranging from 30% to greater than 50% occur in power steering systems utilizing conventional worm gear reduction mechanisms, in which the pinion gear is slidably engaged by a wormscrew.

Antifriction Gearing

Patents on devices designed to reduce power loss or to increase the efficiency of gear mechanism have been issued for more than one hundred years. For example, U.S. Pat. No. 626,515, issued Jun. 6, 1899, to Whitney, discloses a gear mechanism in which the teeth or pins on the driven gear can rotate within sockets so that, upon engagement of the pins with the rotating worm gear threads, sliding contact is replaced by rolling contact. This results in a considerable reduction in friction and a consequent increase in power transfer efficiency.

Other patents disclosing low friction gear mechanisms in which the teeth or pins on the driven gear can rotate include U.S. Pat. No. 715,973, issued Dec. 16, 1902, to Butler, U.S. Pat. No. 908,049, issued Dec. 29, 1908, to Teal, U.S. Pat. No. 1,060,933, issued May 6, 1913, to Myers, U.S. Pat. No. 3,820,413, issued Jun. 28, 1974, to Brackett, U.S. Pat. No. 4,685,346, issued Aug. 11, 1987, to Brackett, U.S. Pat. No. 4,833,934, issued May 30, 1989, to Boyko et al., U.S. Pat. No. 5,901,611, issued May 11, 1999, to Brackett, and U.S. Pat. No. 6,193,014, issued Feb. 27, 2001, to Brackett. Such gears can be referred to as “roller gears” or “roller gear mechanisms,” as the teeth or pins on the gear driven by the threads of the wormscrew shaft rotate. All patents and documents mentioned herein are incorporated by reference as if reproduced herein in full below.

Despite the long felt need for improved efficiency in automotive power assist steering gear reduction mechanisms, roller gear technology has not been utilized. Accordingly, it is desired to provide a power assist steering system that has increased energy transfer efficiency between the electric motor or other power source and the assist pinion.

### SUMMARY OF THE INVENTION

In accordance with the teachings of the present invention, a steering system and method of transferring power to a steering assembly are disclosed. According to one aspect of the present invention, an electric power assist steering system is provided in which an electric motor is operatively engaged to the remainder of the steering system via a roller gear mechanism. The roller gear mechanism leads to increased energy transfer efficiency in comparison to prior art worm drive gear mechanisms, and to increased overall fuel efficiency for the vehicle. This is due to the use of a pinion gear, referred to as a roller wheel, which has pins or teeth that rotate within mounting sockets on the periphery of the pinion gear. The pins rotate upon engagement with a rotating wormscrew (also called “roller screw”) that is turned by a power source (e.g., electric motor or internal combustion motor driven pulley), thus resulting in reduced friction and increased power transfer efficiency. An embodiment of a roller gear of the present invention for use in a power assist steering mechanism of the present invention has a gear ratio of about 15:1 and about 22:1.

These and other features, advantages and objects of the present invention will be further understood and appreciated by those skilled in the art by reference to the following specification, claims and appended drawings. It is to be understood that both the preceding summary and the detailed description that follows are intended merely to be exemplary and to further explain the invention claimed. The invention may be better understood by reference to the following detailed description read in conjunction with the accompanying drawings.

### BRIEF DESCRIPTION OF THE DRAWINGS

FIG. 1 illustrates a typical vehicle steering system.

FIG. 2 illustrates a rack and pinion steering mechanism of an electric power assist steering system, in which an electric motor is attached to an assist pinion gear reduction mechanism.

FIG. 3 illustrates a partial exploded perspective view of an assist pinion with worm gear reduction mechanism, showing the wormscrew detached therefrom and having a portion of the housing cutaway to reveal a portion of the pinion gear.

FIG. 4 illustrates a partial cutaway perspective view of an embodiment of a rack and pinion steering mechanism of the present invention that incorporates a roller gear mechanism coupled to the assist pinion.

FIG. 5 is a side elevation view of the roller wheel, assist pinion, rollerscrew, and mountings for the assist pinion and roller wheel in a roller gear embodiment of the present invention.

FIG. 6 is a bottom perspective view of the roller wheel, assist pinion, assist pinion lower bearing, and rollerscrew of the roller gear components of FIG. 5.

FIG. 7 is a bottom, perspective view of the rollerwheel pins, assist pinion, and rollerscrew of the roller gear components of FIG. 5 with the rollerwheel not shown.

FIG. 8 is a bottom perspective view of a roller pin of the present invention.

FIG. 9 is an alternative embodiment of the roller pin of FIG. 8, including bearings and a bearing retention clip.

FIG. 10 is a top perspective view of the roller pin of FIG. 8 including bearings and a seat.

FIG. 11 graphically illustrates the difference in efficiency between a steering mechanism using a worm gear and a roller gear.

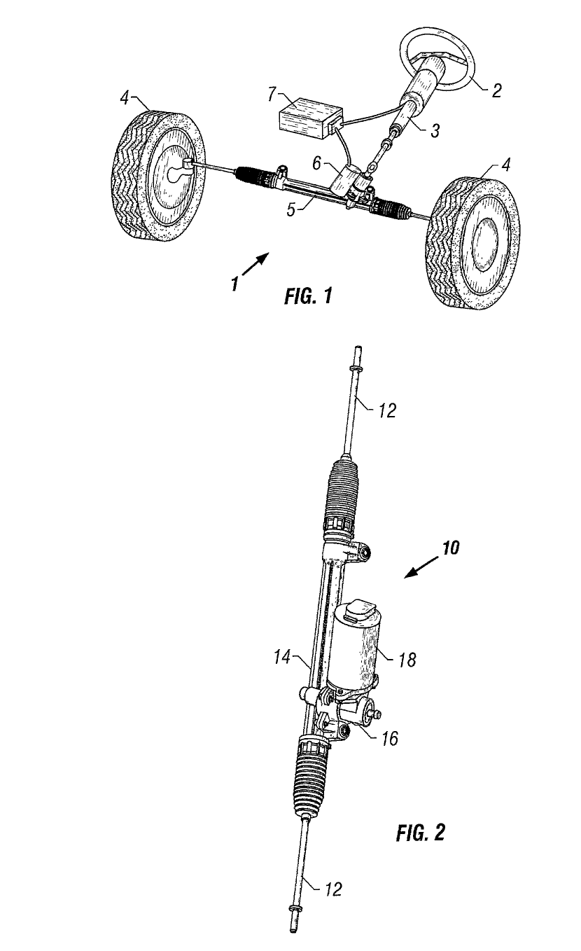

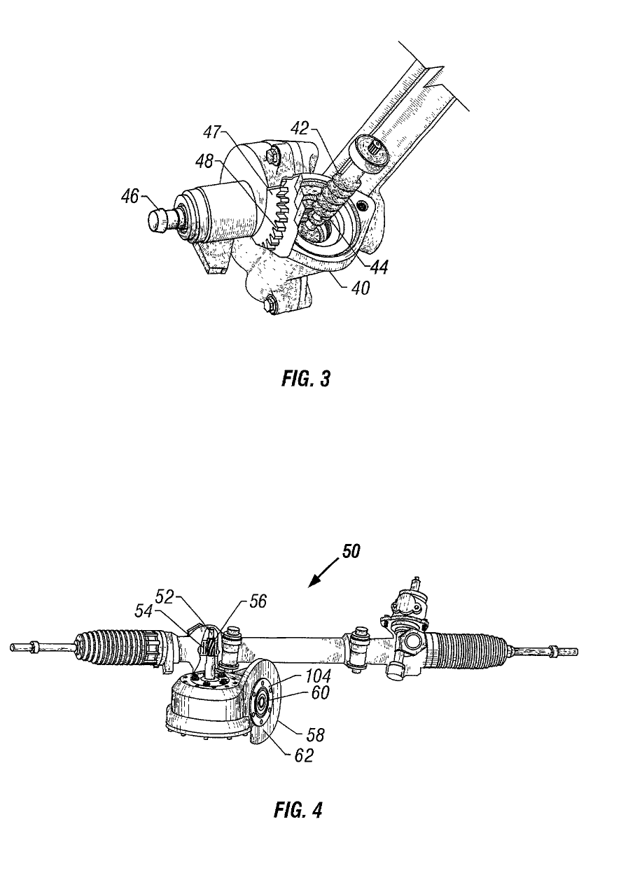

### DETAILED DESCRIPTION OF THE INVENTION

In a preferred embodiment, an electric motor is coupled to a conventional rack and pinion steering mechanism via a roller gear mechanism, which is incorporated into a conventional steering system. However, the present invention may be adapted to many different vehicle types and steering systems that utilize power assist. For example, power drive to the roller gear input may be provided via a belt and pulley mechanism from an internal combustion engine.

Rack and Pinion Mechanism with Roller Gear

With reference to FIG. 4, an embodiment of a rack and pinion steering mechanism 50 of the present invention is illustrated. Part of the rack and pinion housing and the roller gear mount are cutaway to illustrate the interaction of the assist pinion 52 with the rack 54. Helical threads 56 on assist pinion 52 engage corresponding teeth on rack 54. The shape and number of the threads and teeth on the rack and pinion can be varied as with conventional rack and pinion mechanisms. Pinion 52 is mounted in roller gear 58. Roller gear 58 includes an input coupling 60 for a rotating input shaft, which may be the output shaft of an electric motor, such as motor 18 in FIG. 2. Mounting flange 62 is provided for mounting a motor or pulley coupling to roller gear 58. The shape of flange 62 may be varied. Bolts holes may be placed in flange 62 for coupling the roller gear to a power source.

Roller Gear Components

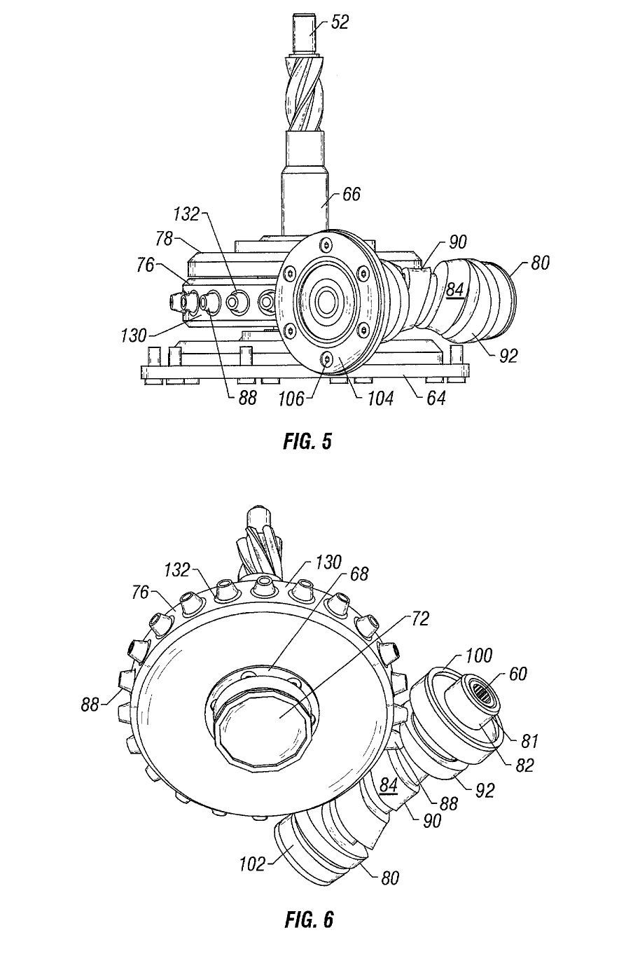

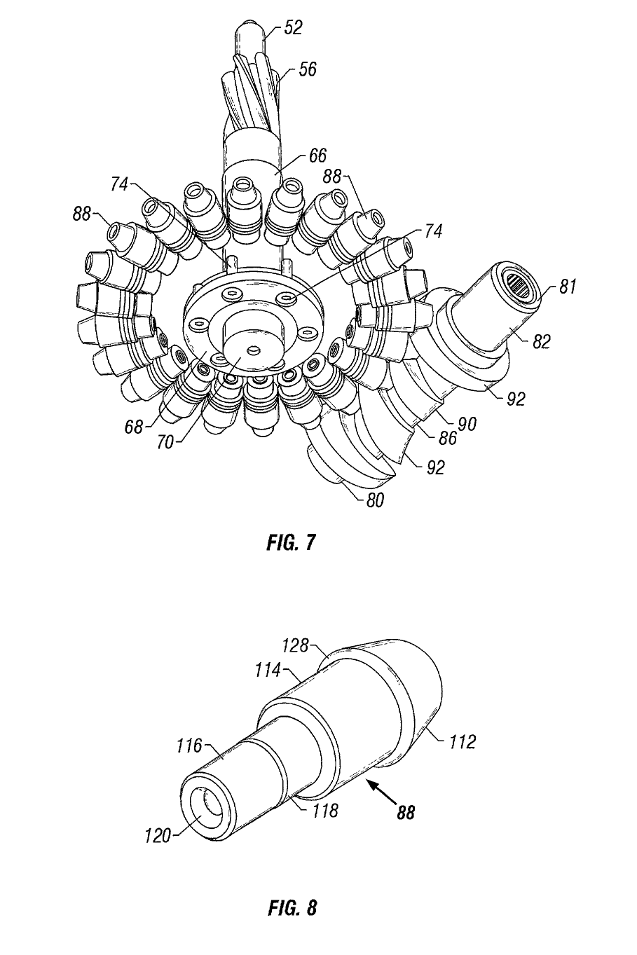

With reference to FIGS. 5, 6 and 7, the components of a roller gear embodiment of the present invention and their mechanism of interaction will be better understood. Assist pinion 52 is rotatably mounted on base plate 64 of the roller gear housing, which is not shown here to reveal the internal components. Assist pinion 52 has a main shaft 66 and an integral annular mounting flange 68. An extension 70 of pinion main shaft 66, best seen in FIG. 7, is rotatably mounted in bearing 72, best seen in FIG. 6. Bearing 72 rests in a matching fitting on base plate 64. Assist pinion 52 is preferably made of steel complying with the same Society of Automotive Engineers (SAE) standards as that used for conventional assist pinions (e.g., SAE 1040 or SAE 8620). For example, the materials and construction of the assist pinion used in gear reduction mechanisms available from Visteon Global Technologies, Inc. of Dearborn, Mich., USA or affiliates thereof, or from Nissei Corporation, of Japan may be used in the present invention.

Bolts 74, best seen in FIG. 7, are used to couple mounting flange 68 to roller wheel 76 shown in FIGS. 5 and 6. Roller wheel 76 may also be referred to as a roller pinion gear. Roller wheel 76 may be of steel, preferably meeting appropriate SAE standards (e.g., SAE 1040), or of a composite or other material of sufficient strength to withstand the requirements for steering assist applications. In an alternative embodiment, roller wheel 76 may be integral with assist pinion main shaft 66. A retaining flange 78, shown in FIG. 5, holds roller wheel 76 in place in the roller gear housing.

Roller screw 80 is mounted perpendicular to roller wheel 76. Roller screw 80 has a main shaft 82 with a spiral threaded portion 84. Input coupling 60 is press fit into a mating opening at the input end 81 of shaft 82. The depth and width of gaps 86 between the threads accommodates the rotating teeth or pins 88 in roller wheel 76. To increase contact between threaded portion 84 and pins 88, threaded portion 84 has an arcuate contacting profile of slightly larger radius of curvature than the radius of curvature of the roller wheel periphery so that the radius of the center threads 90 in the center of the threaded portion 84 is less than the radius of the outer threads 92. In an exemplary embodiment, main shaft 82 has a length of about 130 mm and a diameter of about 20.5 mm, with the threads having a maximum diameter of about 45.5 mm and a minimum diameter of about 30 mm. The shaft in gaps 86 between the threads would generally have the same diameter as the main shaft 82. An exemplary roller wheel for use with the exemplary roller screw has a diameter of about 139.5 mm without pins (i.e., teeth) and about 145.5 mm with teeth. These dimensions can vary depending on the torque and other performance requirements. For example, in an embodiment, the roller wheel has a diameter of about 90 mm, and the other roller gear components are scaled proportionately.

Roller screw 80 is rotatably mounted in the housing 58 at outer bearing 100 and inner bearing 102, with the bearings being seated in corresponding fittings. For example, outer bearing 102 is seated in annular mounting plate 104, which is fixed to housing 58 by bolts 106. Roller screw 80 is preferably formed of heat-treated steel, for example SAE 1040.

Exemplary Assist Pinion Gear Pins

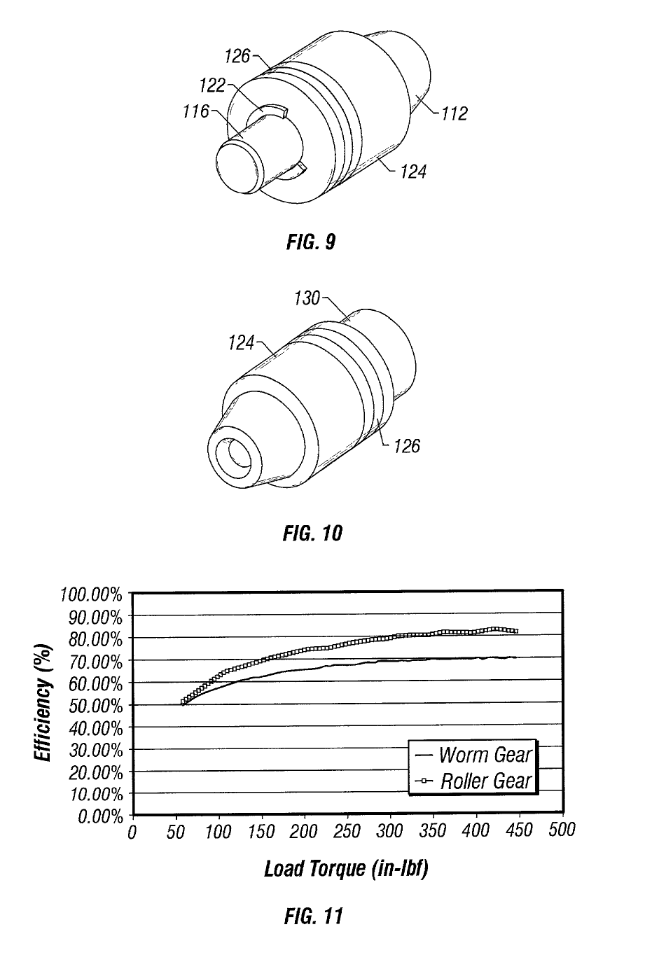

With reference FIGS. 7-10, exemplary embodiments of assist pinion gear pins and fittings are illustrated. An exemplary pin 88 has a frustoconically shaped head 112 on top of a cylindrical base 114, which has a cylindrical base extension 116. A groove 118 is provided in base extension 116 to accommodate a snap fitting, such as a snap-on washer 122. The bottom of base extension 116 may include an optional orifice 120 to provide for an optional spring with ball bearing interface, not shown, to accommodate backlash if desired (backlash refers to the gap between the pins and roller screw shaft). With reference to FIG. 9, it can be seen that base extension 116 does not require the orifice.

With reference to FIGS. 9 and 10, a main pin bearing 124 is provided on base 114 along with washers 126. Main pin bearing 124 is held against stop 128, shown in FIG. 8, by washers 126 and washer 122. With reference to FIG. 10, base extension 116 is shown seated in fitting 130.

With reference to FIGS. 5-7, a plurality of pins 88 are inserted in a plurality of orifices about the peripheral wall 130 of roller wheel 76, and are held in by internal snaps rings 132. Pins 88 can rotate within the orifices.

In an exemplary embodiment, 22 pins are inserted in the exemplary roller wheel described above for use with the exemplary roller screw described above. Each pin has an overall length of about 31 mm, head length of about 8 mm, base length of about 9.5 mm, and the snap ring groove is about 7 mm from the base. The pin has a maximum diameter at the stop of about 9 mm and tapers down to about 8 mm. The pins are preferably fabricated from hardened steel meeting an appropriate SAE standard. Preferably, the roller gear components are immersed in a lubricant bath within the housing. For example, a suitable lubricant meets SAE standards for lubricants used in conventional worm gears. In an exemplary embodiment, the assist pinion has an overall length of about 182 mm and a main shaft diameter of about 27 mm, although these dimensions can vary depending on the performance requirements and materials.

Thus, the pinion gear, or “roller pinion gear,” of the present invention for use in a power assist steering system comprises a roller wheel having a plurality of radially projecting teeth about its periphery, wherein the teeth comprise pins rotatably mounted in and projecting from the periphery of the roller wheel. The assist pinion shaft can be coupled to the roller wheel or integrally formed therewith. The pinion gear of the present invention makes it possible to extend the use of 12 volt electric power assist motors to larger vehicles where a 42 volt motor or a hydraulic system might otherwise be used. In other embodiments, other voltages may be used, including 42 volt motors.

### EXAMPLE 1

A comparison of the efficiency of a roller gear of the present invention versus the efficiency of a conventional worm gear used in conventional dual pinion electric power steering systems was conducted. The roller gear and worm gear both had a gear ratio of 22:1, and were tested with 1000 revolutions per minute (rpm) input over load torques ranging from about 50 in-lbf to about 450 in-lbf. The torque in this case approximates the assist torque required to steer a typical pickup (e.g., Ford F-series, Chevrolet Silverado, etc.). The test setup included a hydraulic motor to drive the input (worm screw or roller screw). Pinion torque was provided by a hydraulic pump. The set-up schematic in linear sequence was hydraulic motor, torque/speed sensor, gearbox input, gearbox output, torque/speed sensor, and hydraulic pump. The hydraulic motor was maintained under closed loop control to maintain speed, and the hydraulic pump was maintained under closed loop control to ramp (i.e., increase) torque. This set-up permits torque to be adjusted independently of speed. Input speed and output speed were checked to ensure they maintained the proper ratio, and output torque was compared to input torque to calculate efficiency.

The test roller gear had a roller wheel with a diameter of 139.5 mm without pins (i.e., teeth) and about 145.5 mm with teeth, and the roller screw main shaft had a diameter of about 20.5, with the threads having a maximum diameter of about 45.5 mm and a minimum diameter of about 30 mm.

With reference to FIG. 11, a graphical illustration is provided of the higher efficiency over the load torque range indicated of the roller gear versus the worm gear. While the maximum efficiency of the worm gear was about 70%, the roller gear had a peak efficiency that exceeded 80%. In fact, for all load torques greater than 200 in-lbf at 1000 rpm, the efficiency of the roller gear was greater than 70%.

Because of this increase in efficiency, it is possible to use 12 volt electric motors in larger vehicle power steering systems than was previously possible. For example, Table 1 below provides exemplary specifications for a roller gear for use in a truck or sport utility vehicle (SUV). For example, a Ford Explorer with a 12 volt system could utilize a roller gear to couple an electric motor to a rack and pinion steering mechanism. In Table 1, the roller wheel maximum torque is 18.7 times that of the roller screw, while the roller screw maximum speed is 28.6 times that of the worm wheel. This variance accounts for the loss in efficiency.

TABLE 1
Exemplary Roller Gear Specifications For Use in Trucks and
SUVs

| | |
|---|---|
| Gear Ratio | 22:1 |
| Roller Wheel - Max Speed | 210 rpm |
| Roller Wheel - Max Torque | 840 in-lbf |
| Roller Screw - Max Speed | 6000 rpm |
| Roller Screw - Max Torque | 45 in-lbf |
| Operating Temperature Range | −40° C. to 150° C. |
| Humidity & Dust | Protected |

While embodiments have been disclosed of a new pinion gear for a vehicle power assist steering system, a new rack and pinion vehicle steering mechanism incorporating the new pinion gear, and an electric power assist steering system incorporating the new pinion gear as examples herein, there could be a wide range of changes made to these embodiments without departing from the present invention.

Thus, it is intended that the foregoing detailed description be regarded as illustrative rather than limiting and that it be understood that it is the following claims, including all equivalents, which are intended to define the scope of the invention.

What is claimed is:

1. A roller pinion gear for use in a power assist steering system, comprising a roller wheel having a plurality of radially projecting teeth about its periphery, wherein said teeth comprise pins rotatably mounted in and projecting from the periphery of said roller wheel.

2. The pinion gear of claim 1, further comprising a pinion shaft coupled to the roller wheel.

3. An assist pinion mechanism for a power assist steering system, comprising an assist pinion, and a roller pinion gear, wherein said assist pinion has a first end and a second end, wherein said first end may engage a rack, and said second end is coupled to said pinion gear, wherein said pinion gear comprises a roller wheel having a plurality of radially projecting teeth about its periphery, wherein said teeth comprise pins rotatably mounted in and projecting from the periphery of said roller wheel.

4. The pinion mechanism of claim 3, further comprising a roller screw, wherein said roller screw has a threaded portion having helical threads thereon, and said threaded portion is situated to engage at least one of said pins upon rotation of said roller screw.

5. The pinion mechanism of claim 4, further comprising an electric motor having a rotating output shaft, wherein said output shaft is coupled to said roller screw.

6. The pinion mechanism of claim 5, wherein the gear ratio between said roller screw and said assist pinion is between about 15:1 and about 22:1.

7. The pinion mechanism of claim 5, wherein the gear ratio between said roller screw and said assist pinion is about 22:1.

8. The pinion mechanism of claim 5, wherein said mechanism has a power transfer efficiency greater than 70% at load torques above 200 in-lbf at 1000 rpm.

9. The pinion mechanism of claim 4, wherein said threaded portion of said roller screw has an arcuate contacting profile with regard to said roller wheel pins.

10. A power assist steering system, comprising a rack, an assist pinion, and a pinion gear, wherein said assist pinion has a first end and a second end, wherein said first end engages said rack, and said second end is coupled to said pinion gear, wherein said pinion gear comprises a roller wheel having a plurality of radially projecting teeth about its periphery, wherein said teeth comprise pins rotatably mounted in and projecting from the periphery of the roller wheel.

11. The steering system of claim 10, further comprising a roller screw, wherein said roller screw has a threaded portion having helical threads thereon, and said threaded portion is situated to engage at least one of said pins upon rotation of said roller screw.

12. The steering system of claim 11, further comprising an electric motor having a rotating output shaft, wherein said output shaft is coupled to said roller screw.

13. The steering system of claim 11, wherein said roller screw and said pinion gear have a gear ratio with respect to each other of about 15:1 to about 22:1.

14. The steering system of claim 12, wherein the gear ratio between said roller screw and said assist pinion is about 22:1.

15. The steering system of claim 12, wherein the efficiency of torque transfer from the output of said motor to said assist pinion is greater than 70% at load torques above 200 in-lbf at 1000 rpm.

16. A power assist steering system, comprising an electric motor having a rotating output shaft, a steering mechanism, and a roller gear coupling said electric motor output shaft to said steering mechanism.

17. The steering system of claim 16, wherein said steering system comprises an assist pinion, and the power transfer efficiency between said output shaft and said assist pinion is greater than 70% at load torques above 200 in-lbf at 1000 rpm.

18. A method for transferring power from a rotating input shaft to an assist pinion in a power assist steering system, comprising coupling an assist pinion that forms part of a steering system to a rotating input shaft via a roller pinion gear, wherein the pinion gear comprises a roller wheel having a plurality of radially projecting teeth about its periphery, wherein said teeth comprise pins rotatably mounted in and projecting from the periphery of the roller wheel.

19. The method of claim 18, wherein said rotating input shaft turns a roller screw having helical threads thereon, wherein upon rotation of the roller screw at least one thread contacts at least one of said pins.

20. The method of claim 18, wherein the power transfer efficiency between said rotating input shaft and said assist pinion is greater than 70% at load torques above 200 in-lbf at 1000 rpm.

21. The method of claim 19, wherein the gear ratio between said rotating input shaft and said assist pinion is between about 15:1 to about 22:1.

22. The method of claim 19, wherein the gear ratio between said rotating input shaft and said assist pinion is about 22:1
